(19) United States
(12) Patent Application Publication
(10) Pub. No.: US 2010/0124679 A1
(43) Pub. Date: May 20, 2010

(54) METHOD FOR INCREASING THE DURABILITY OF DIRECT OXIDATION FUEL CELLS

(75) Inventors: James Prueitt, Ballston Lake, NY (US); Zhigang Qi, Schenectady, NY (US); Guoqiang Lu, Latham, NY (US); Charles Carlstrom, Saratoga Springs, NY (US)

Correspondence Address: BURNS & LEVINSON, LLP, 125 SUMMER STREET, BOSTON, MA, 02110, US

(73) Assignee: MTI MicroFuel Cells, Inc., Albany, NY (US)

(21) Appl. No.: 12/274,822

(22) Filed: Nov. 20, 2008

(51) Int. Cl. H01M 8/10

(52) U.S. Cl. 429/13

(57) ABSTRACT

Methods for increasing the durability of direct oxidation fuel cells are disclosed. In one instance, the method for increasing durability of a vapor fed direct oxidation fuel cell includes reducing fluctuations in output power, provided by the vapor fed direct oxidation fuel cell, to a load. The reduction of the fluctuations in output power can include, in one instance, utilizing a mass flow controller or an electro-osmotive pump to supply fuel to the vapor fed direct oxidation fuel cell.

### BACKGROUND

This invention relates generally to methods for increasing the durability of direct oxidation fuel cells, and, more particularly, to increasing the durability of vapor fed direct oxidation fuel cells.

Fuel cells are devices in which an electrochemical reaction is used to generate electricity. A variety of materials may be suited for use as a fuel depending upon the materials chosen for the components of the cell. Organic materials, such as methanol, are attractive fuel choices due to their high specific energy.

Fuel cell systems may be divided into “reformer-based” systems (i.e., those in which the fuel is processed in some fashion to extract hydrogen from the fuel before the resulting hydrogen mixture is introduced into the fuel cell system) or “direct oxidation” systems in which the fuel is fed directly into the cell without the need for separate internal or external processing. Most currently available fuel cells are reformer-based fuel cell systems. However, because fuel processing is complex and generally requires expensive components, which occupy significant volume, reformer based systems are presently limited to comparatively large, high power applications. Direct oxidation fuel cell systems may be better suited for a number of applications in smaller mobile devices (e.g., mobile phones, handheld and laptop computers), as well as in some larger applications.

In direct oxidation fuel cells of interest here, a carbonaceous liquid fuel (typically neat methanol or a highly concentrated methanol solution) is introduced to the anode face of a membrane electrode assembly (MEA) as vapor, and oxygen, preferably from ambient air, is used as the oxidizing agent. The fundamental reactions are the anodic oxidation of the fuel mixture into CO₂, protons, and electrons; and the cathodic combination of protons, electrons and oxygen into water. The overall reaction may be limited by the failure of either of these reactions to proceed to completion at an acceptable rate, as is discussed further hereinafter.

Typical DMFC systems include a fuel source, fluid and effluent management systems, and air management systems, as well as a direct methanol fuel cell engine (“fuel cell”). The fuel cell engine typically consists of a housing, hardware for current collection and fuel and air distribution, and membrane electrode assemblies disposed within the housing.

The electricity generating reactions and the current collection in a direct oxidation fuel cell system generally take place within the MEA. In the fuel oxidation process at the anode, the products are protons, electrons and carbon dioxide. The protons migrate through the membrane electrolyte, which is impermeable to the electrons. The electrons travel through an external circuit, which connects the load, and are united with the protons and oxygen molecules in the cathodic reaction, thus providing electrical power from the fuel cell.

A typical MEA includes a centrally disposed protonically-conductive, electronically non-conductive membrane (“PCM”). One example of a commercially available PCM is NAFION®, a registered trademark of E.I. DuPont de Nemours and Company, a cation exchange membrane based on polyperflourosulfonic acid, in a variety of thicknesses and equivalent weights. The PCM is typically coated on each face with an electrocatalyst such as platinum, or platinum/ruthenium mixtures or alloy particles. On either face of the catalyst coated PCM, the electrode assembly typically includes a diffusion layer. The diffusion layer on the anode side is employed to evenly distribute the fuel mixture across the catalyzed anode face of the PCM, while allowing the gaseous product of the reaction, typically carbon dioxide, to move away from the anode face of the PCM. In the case of the cathode side, a diffusion layer is used to allow a sufficient supply of and a more uniform distribution of gaseous oxygen across the cathode face of the PCM, while minimizing or eliminating the collection of liquid, typically water, on the cathode aspect of the PCM. Each of the anode and cathode diffusion layers also assist in the collection and conduction of electric current from the catalyzed PCM through the load.

Direct oxidation fuel cell systems for portable electronic devices should be as small as possible at the power output required. The power output is governed by the rate of the reactions that occur at the anode and the cathode of the fuel cell. More specifically, the anode process in direct methanol fuel cells based on acidic electrolytes, including polyperflourosulfonic acid and similar polymer electrolytes, involves a reaction of one molecule of methanol with one molecule of water. In this process, the oxygen atom in the water molecule is electrochemically activated to complete the oxidation of methanol to a final CO₂ product in a six-electron process.

More specifically, direct methanol fuel cell system produces electricity without combustion. The electrochemical reaction equations are as follows:

Anode:

a. CH₃OH+H₂O=CO₂+6H⁺+6e⁻ Equation 1

Cathode:

b. 6H⁺+6e⁻+3/2O₂=3H₂O Equation 2

Net Process:

c. CH₃OH+3/2O₂=CO₂+2H₂O Equation 3

Generation of electricity continues until one of the reactants is not available. DMFCs are typically described as “on” i.e. providing electrical current by reacting the fuel and oxygen to generate electricity. Those skilled in the art will recognize that fuel can be delivered to the anode aspect of the MEA as a liquid, or in vaporous form.

One difficulty which has been encountered with direct methanol fuel cells is performance degradation (also referred to as reduction in durability or reduction in lifetime), which, in one instance, can be observed as a decrease in fuel cell output power over time at a given current or voltage. The decay rates are typically very high and can be around 50% after being run for a week or so. For example, Kim reported that the power density of a methanol vapor feed DMFC dropped from about 33 to 25 mW/cm² after 5 days of tests (HaeKyoung Kim, Passive direct methanol fuel cells fed with methanol vapor, Journal of Power Sources 162 (2006) 1232-1235). For another example, Zhen-Bo Wang et al. reported that the peak power density of a DMFC fed with 1 M methanol decreased from 70 to 40 mW/cm² after being tested for about 110 hours (Zhen-Bo Wang, Harry Rivera, Xin-Peng Wang, Hong-Xin Zhang, Peter-Xian Feng, Emily A. Lewis, Eugene S. Smotkin, Catalyst failure analysis of a direct methanol fuel cell membrane electrode assembly, Journal of Power Sources 177 (2008) 386-392). A number of factors affect the durability of direct methanol fuel cells (DMFCs) including low reactant flows, high and low humidification levels, and high and low temperatures (see, for example, Shanna D. Knights, Kevin M. Colbow, Jean St-Pierre, David P. Wilkinson, Aging mechanisms and lifetime of PEFC and DMFC, Journal of Power Sources 127 (2004) 127-134; F. A. de Bruijn, V. A. T. Dam, and G. J. M. Janssen, Review: Durability and Degradation Issues of PEM Fuel Cell Components, FUEL CELLS 08, 2008, No. 1, 3-22; both of which are incorporated by reference herein in their entirety).

Methods for improving the durability of direct methanol fuel cells are needed.

### BRIEF SUMMARY

In one instance, the method of these teachings for increasing durability of a vapor fed direct oxidation fuel cell includes reducing fluctuations or noises in output power, provided by the vapor fed direct oxidation fuel cell, to a load. The fluctuations and noises are all together called fluctuations hereinafter.

Other embodiments of the method of these teachings are also disclosed.

### BRIEF DESCRIPTION OF THE DRAWINGS

Aspects of the present teachings are pointed out with particularity in the appended claims. The present teachings are illustrated by way of example in the following drawings in which like references indicate similar elements. The following drawings disclose various embodiments of the present teachings for purposes of illustration only and are not intended to limit the scope of the teachings. For purposes of clarity, not every component may be labeled in every figure. In the figures:

FIG. 1 is an isometric illustration of a previously disclosed fully assembled direct oxidation fuel cell;

FIG. 2 is a simplified schematic illustration of a previously disclosed direct oxidation fuel cell;

FIG. 3 is a cross-sectional view of the fuel cell system including the methanol delivery film, and in which carbon dioxide is routed out of the anode vapor chamber;

FIG. 4 depicts the decay behavior of the exemplary vapor fed DMFC fed from a syringe pump when significant current fluctuation occurs;

FIG. 5 shows for the decay behavior of the exemplary vapor fed DMFC fed from the syringe pump when much less current fluctuation occurs;

FIG. 6a illustrates results for decay in the performance of the exemplary vapor fed DMFC providing less fluctuating output power to a load and fed by a mass flow controller;

FIG. 6b shows results for characteristics of the methanol flow rate when the exemplary vapor fed DMFC is fed from the mass flow controller;

FIG. 7 shows the polarization curves, the graphical relationship between fuel cell current and voltage or power density, obtained for the vapor fed DMFC fed from the mass flow controller;

FIG. 8a illustrates results for decay in the performance of the exemplary vapor fed DMFC providing less fluctuating output power to a load and fed by an electro-osmotic pump;

FIG. 8b shows results for characteristics of the methanol flow rate when the exemplary vapor fed DMFC is fed from the electro-osmotic pump; and

FIG. 9 shows the polarization curves, the graphical relationship between fuel cell current and voltage or power density, obtained for the vapor fed DMFC fed from an electro-osmotic pump.

### DETAILED DESCRIPTION

The present teachings may be understood by the following detailed description, which should be read in conjunction with the attached drawings. The following detailed description of certain embodiments is by way of example only and is not meant to limit the scope of the present teachings.

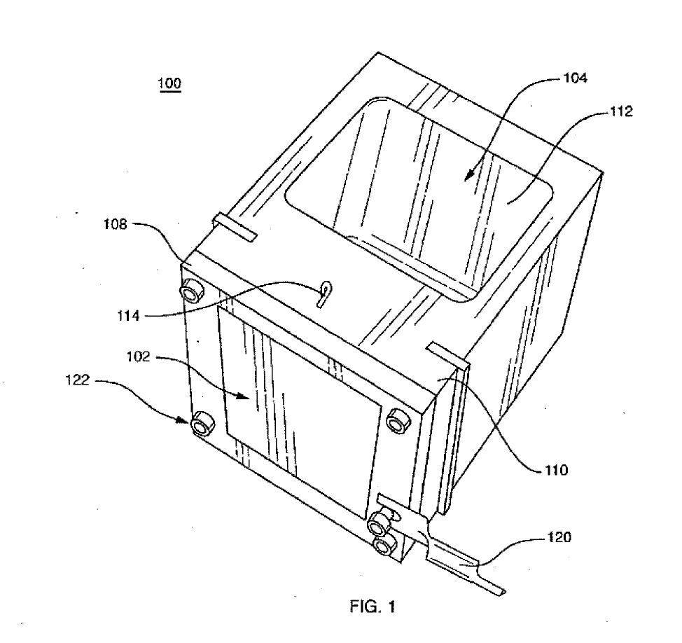

In order to aid in the disclosure of the present teachings, an exemplary embodiment, not a limitation of the present teachings, of a vapor fed direct oxidation fuel cell is presented below (the exemplary embodiment presented below is disclosed in US Patent Application Publication No. 2005/0170224, which is incorporated by reference herein in entirety) and shown in FIGS. 1, 2 and 3.

FIG. 1 illustrates a direct oxidation fuel cell system 100 that includes a direct oxidation fuel cell 102 in conjunction with a fuel reservoir 104. The fuel cell 102 is held together by a frame 108 and it is encapsulated within a plastic exterior housing 110, which may be comprised of a plastic. The fuel reservoir 104 has a recess 112 into which fuel or a fuel cartridge is inserted to begin the delivery of fuel to the anode portion of the fuel cell as will be discussed in further details hereinafter. In FIG. 1, the active surface of the cathode is located on the aspect corresponding to the front face of the cell as shown. The anode current collection lead 114 is in Ohmic contact with the anode current collector (hidden in FIG. 1) and can be connected with the cathode current collector lead 120 through a load to form an electrical circuit and the load utilizes the electricity produced by the fuel cell. Bolts 122 provide significant compression on the frame of the cell, translated to the main surface of the membrane/electrode assembly by rigid current collectors, thereby ensuring good uniform contact among cell components.

Many alternative fuel cell architectures are within the scope of the present teachings. Further, the illustrative embodiment of the invention is a DMFC with the fuel substance being substantially comprised of neat methanol. It should be understood, however, that it is within the scope of the present teachings that other fuels may be used in an appropriate fuel cell. Thus, as used herein, the word fuel shall include methanol and ethanol or combinations thereof and other carbonaceous substances and aqueous solutions thereof, that are amenable for use in direct oxidation fuel cells and fuel cell systems. While in describing some exemplary embodiments the direct oxidation fuel cell is referred to as a direct methanol fuel cell, it should be noted that the present teachings are not limited to only that exemplary embodiment.

The fuel cell 200 includes a catalyzed membrane electrolyte 204. As noted, one example of the material that may be used for the catalyzed membrane, which is commercially available, is Nafion®, a registered trademark of E.I. DuPont de Nemours and Company, a cation exchange membrane based on a polyperflourosulfonic acid in a variety of thicknesses and equivalent weights. Other proton exchange membranes include hydrocarbon membranes. The membrane is typically coated on each of its major surfaces with an electrocatalyst such as platinum or a platinum/ruthenium mixture or alloyed particles. Thus, it is referred to herein as the “catalyzed membrane electrolyte.” The catalyzed membrane electrolyte sandwich may be constructed according to any of the various available fabrication techniques, or other fabrication techniques, while still remaining within the scope of the present invention.

One face of the catalyzed membrane electrolyte 204 is the anode face or anode aspect 206. The opposing face of the catalyzed membrane electrolyte 204 is on the cathode side and is herein referred as the cathode face or the cathode aspect 208 of the membrane electrolyte 204. The carbonaceous fuel substance, which in this instance is neat methanol, is introduced through an anode mass transport control layer 209, and in one embodiment, it is a methanol delivery film.

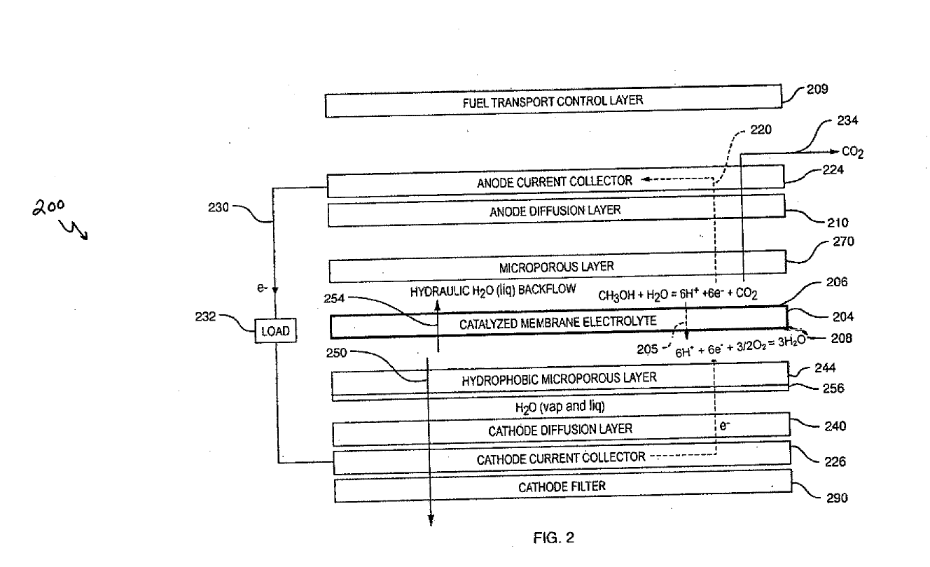

As shown in FIG. 2, the anode reaction is: CH₃OH+H₂O=CO₂+6H⁺+6e⁻. In accordance with this reaction, one molecule of methanol and one molecule of water react at the anode face 206 of the membrane electrolyte 204, the result of which is that 6 protons (6H⁺) cross through the membrane 204. This is made possible by the well-hydrated Nafion® substance of the membrane, which allows the protons to be carried across the membrane 204, as illustrated by the dashed arrow, 205. The electrons generated in the process, are conducted as illustrated by the dashed arrow 220 to the anode current collector 224, which is connected via wires 230 and a load 232 to the cathode current collector 226. The carbon dioxide formed at the anode face 206 is (in the embodiment of FIG. 2), vented through the anode diffusion layer 210 out of the fuel cell as illustrated by the arrow 234.

On the cathode side, ambient air is introduced into the cathode portion via a cathode filter (not shown in FIG. 2) and the cathode diffusion layer 240. The cathode diffusion layer is sometimes referred to herein as a “cathode backing layer.” At the cathode aspect 208 of the membrane 204, the reaction is 6H⁺+6e⁻+3/2O₂=3H₂O. Thus, the protons and electrons combine with oxygen from the ambient air at the cathode face 208 to form water (H₂O).

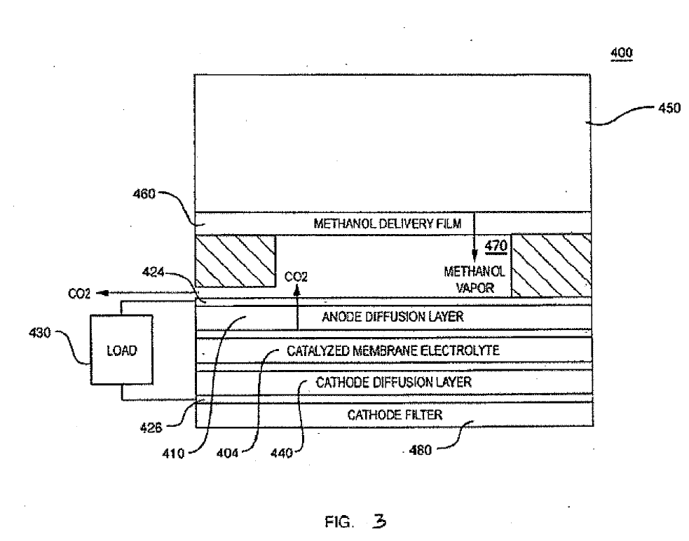

In another exemplary embodiment, a methanol vapor delivery film can instead be used for layer 209 in FIG. 2, to deliver fuel to the anode aspect at the appropriate rate. Referring now to FIG. 3, a cross section of a fuel cell system 400, in accordance with the present invention, which includes a methanol vapor delivery film, is illustrated. The catalyzed membrane electrolyte 404 is sandwiched between an anode diffusion layer 410 and a cathode diffusion layer 440. The current collected is passed through load 430, which is coupled across anode current collector 424 and cathode current collector 426. A fuel reservoir 450, which may be a separate or detachable fuel cartridge, or may be a part of the fuel cell itself, stores a methanol fuel solution, which is preferably 50% methanol or greater, and most preferably neat methanol, for supplying the fuel cell. The methanol delivery film 460 of the present exemplary embodiment is a membrane that is placed as one wall of the fuel reservoir 450.

Durability (lifetime) can be decreased as a result of catalyst, membrane, carbon degradation/oxidation, all of which are affected by variations in fuel concentration.

In one embodiment, the method of these teachings for increasing durability of vapor fed direct oxidation fuel cells includes reducing fluctuations in the output power, provided by the vapor fed direct oxidation fuel cell, to a load. It was discovered, through a series of measurements under various conditions, that reducing the fluctuations in the output power reduces the catalyst, membrane and carbon degradation.

In one embodiment, the fuel is neat methanol and the fuel cell is a vapor fed direct methanol fuel cell (VFDMFC).

In order to better illustrate the present teachings, results of application of an exemplary embodiment of the method of this teachings to an exemplary vapor fed DMFC are disclosed herein below. It should be noted that these teachings are not limited to only the exemplary embodiment presented herein below.

Results are presented herein below for desired neat methanol with cell temperature of about 80° C., and air humidification temperature of about 78° C. The methanol utilization, defined as the percentage of methanol participating in the electrochemical reaction out of the total amount of fuel input, was managed to be higher than 50%. During the life testing of the fuel cells both the open circuit voltage (OCV) and the voltage-current polarization curves were checked and collected periodically.

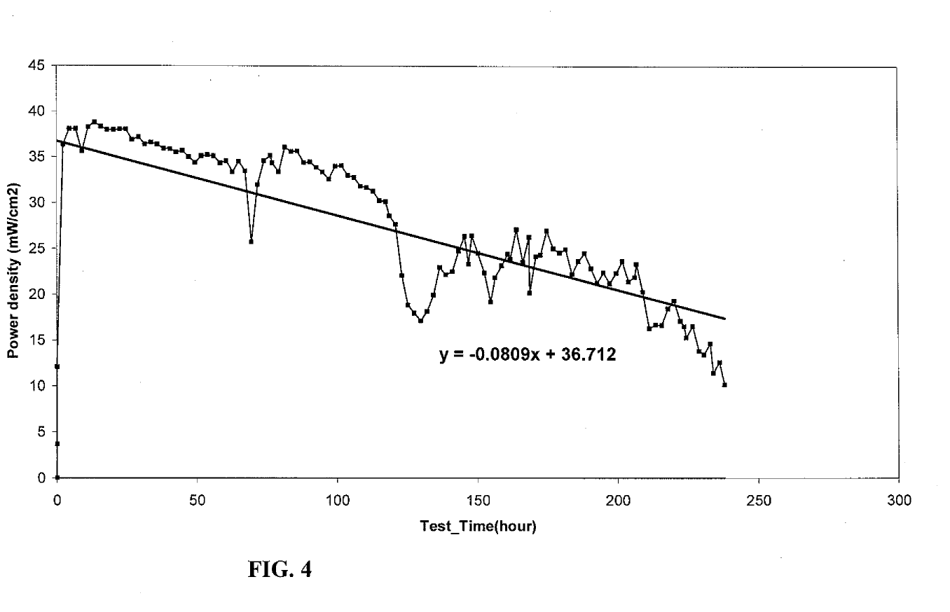

FIG. 4 shows the results obtained for constant voltage operation (at 0.51 V) of the exemplary vapor fed DMFC fed from using a syringe pump. Syringe pumps are conventionally and still popularly used to feed fuel to a fuel cell. At constant voltage mode using a syringe pump to supply the fuel, the current can be allowed to fluctuate significantly. The observed output power (or output power density) variations (fluctuations) are shown in FIG. 4 along with the fuel cell power density degradation (decay). The output power (output power density) exhibits fluctuations of sometimes greater than 50%. Clearly, the fuel cell performance decayed significantly.

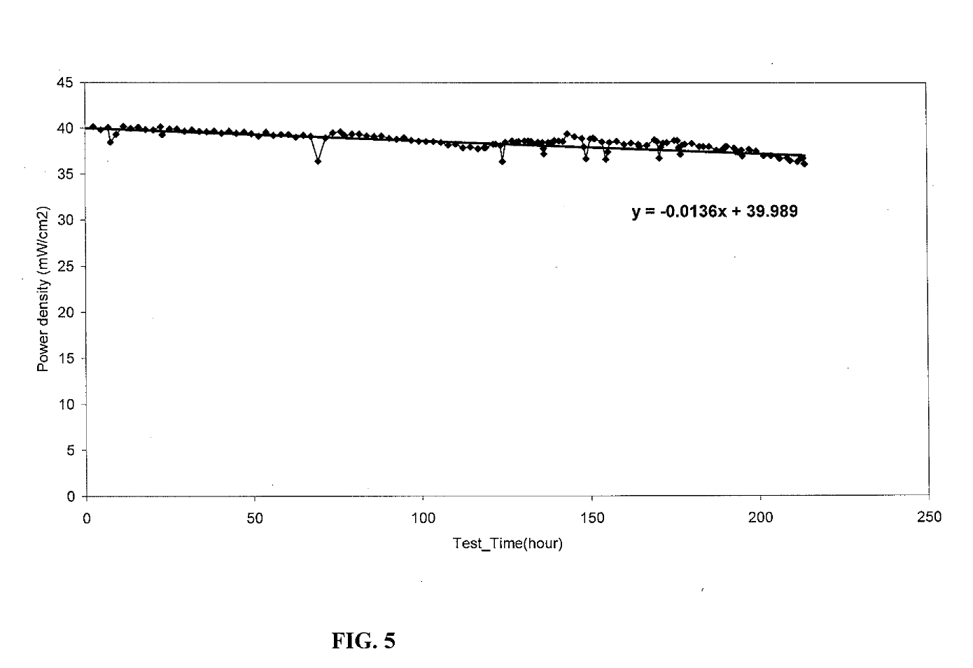

In contrast, FIG. 5 depicts results for the constant current operation (at 1 amp) behavior of the exemplary vapor fed DMFC fed from the syringe pump. In the constant current mode, since the current is kept substantially constant, fluctuations in the output power (and output power density) of the fuel cell are strongly reduced. Comparison with the results depicted in FIG. 4, it indicates that the durability of the vapor fed DMFC is increased by reducing fluctuations in output power of the vapor fed DMFC. It should be noted that, in FIG. 5, the amplitude fluctuations in output power is less than 50% and the frequency of the output power fluctuations is lower than 0.1 Hz.

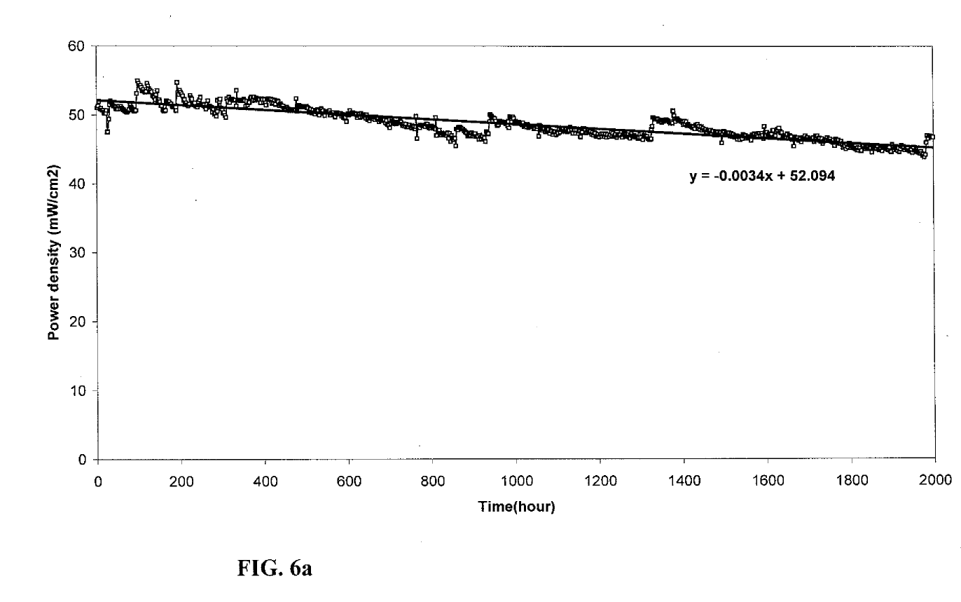

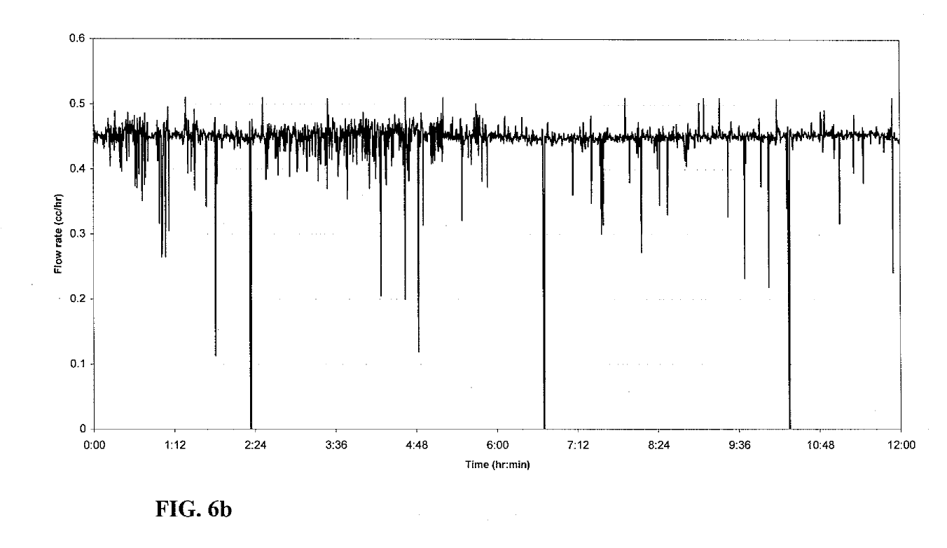

The improved durability of a vapor feed DMFC when reduced output power fluctuation is implemented is also illustrated by FIG. 6a, where a mass flow controller was used to supply the methanol fuel to the anode. As can be seen from FIG. 6a, the power density only decayed by about 13% in 2000 hours of operation, exhibiting a decay rate of about 0.6% per 100 hours.

The characteristics of the methanol flow rate when the vapor fed DMFC is fed from a mass flow controller is shown in FIG. 6b. Although the flow rates obtained when utilizing the mass flow controller exhibit variations between about 0.5 to about 0.0 ml/hr, the variations occur significantly less frequently than those observed when utilizing the syringe pump.

A conventional mass flow controller includes an inlet port, an outlet port, a mass flow sensor, a proportional control valve, and a closed loop control system for adjusting the proportional valve accordingly to achieve the required flow.

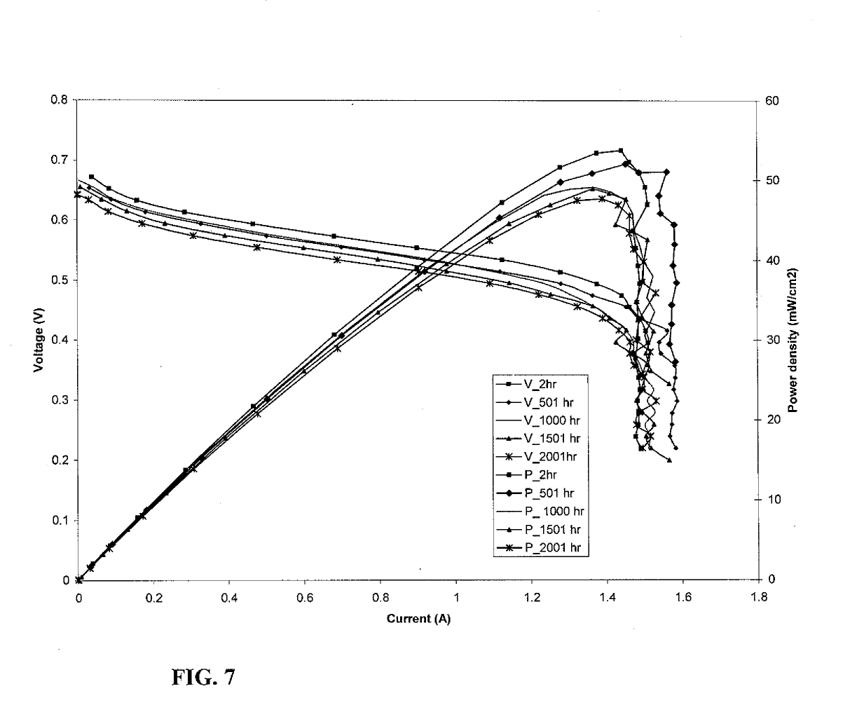

FIG. 7 shows the polarization curves, the graphical relationship between fuel cell current and voltage or power density, for the vapor fed DMFC fed from the mass flow controller. As shown in FIG. 7, the polarization curves show a slight decay in performance with operating time, and the current at which the peak power occurred did not vary significantly with increasing hours of operation.

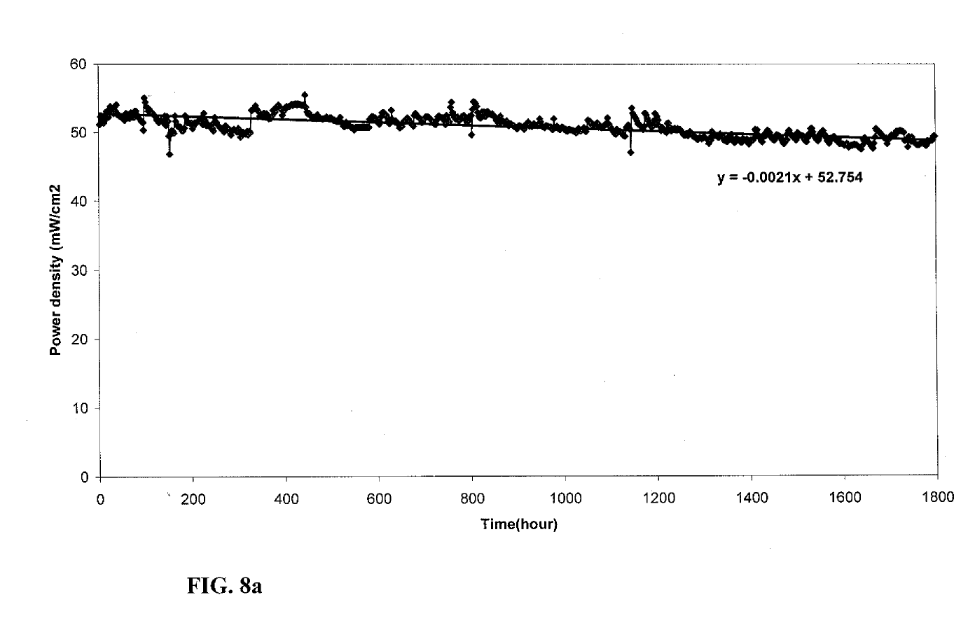

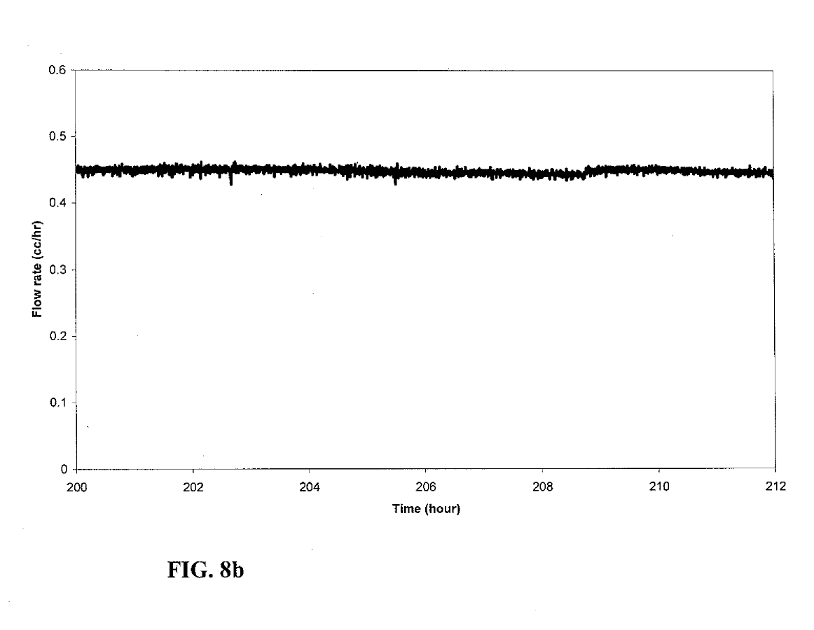

The improved durability of a vapor feed DMFC when reduced output power fluctuation is implemented is further illustrated by FIG. 8a, where an electro-osmotic pump was used to provide a substantially steady flow of the methanol fuel to the anode. As can be seen from FIG. 8a, the power density decayed by less than about 8% in 1800 hours of operation, exhibiting a decay rate of only about 0.4% per 100 hours.

An electro-osmotic pump contains no moving parts and is capable of moving fluids through tight spaces. Electro-osmotic pump advantageously can move fluid with low or no conductivity. An electro-osmotic flow is created when a DC potential is applied across a porous media. The methanol liquid in the porous media is driven from the positive electrode to the negative electrode, when exposed to the DC electrical field. Electro-osmotic pump is useful in micro-channels, and in slow and controlled flow. Electro-osmotic flow is discussed, for example (these teachings not being limited only to the examples), in U.S. Pat. No. 3,923,426 entitled, “Electroosmotic Pump and Fluid Dispenser Including Same,” issued on Dec. 2, 1975; and in S. Yao, A. M. Myers, J. D. Posner, K. A. Rose, and J. G. Santiago, Electroosmotic Pumps Fabricated from Porous Silicon Membranes, Journal of Microelectromechanical Systems, Vol. 15, No. 3, 2006; both of which are incorporated by reference herein in their entirety.

The characteristics of the methanol flow rate when the vapor fed DMFC is fed from the electro-osmotic pump is shown in FIG. 8b. The characteristics of the methanol flow rate shown in FIG. 8b and the results of FIG. 8a are obtained when the electro-osmotic pump is controlled by a pump driver controller, such as, but not limited to, the configuration shown in US Patent Application publication ______, corresponding to U.S. patent application Ser. No. 12/274,567 (Attorney Docket number 41488-101), FUEL CELL FEED SYSTEMS, both of which are incorporated by reference herein in their entirety, in U.S. Pat. No. 7,231,839, Electroosmotic micropumps with applications to fluid dispensing and field sampling, incorporated by reference herein in its entirety and in Buie, C. R., Kim, D., Litster, S. E., and J. G. Santiago, “Electro-osmotive Pumps for Direct Methanol Fuel Cells,” Electrochemical and Solid-State Letters, 10 (11) B196-B200 (2007), which is incorporated by reference herein in its entirety.

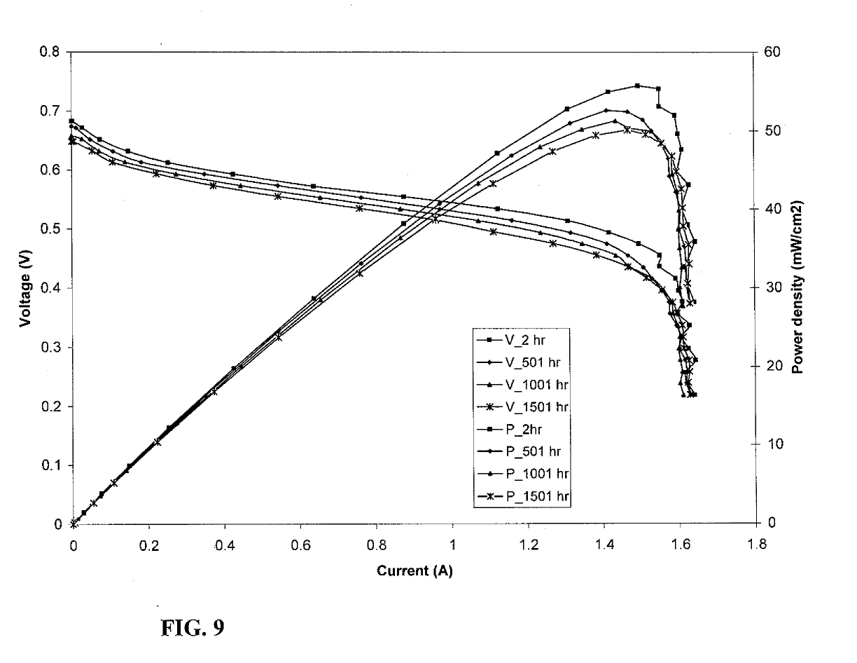

FIG. 9 shows the polarization curves, the graphical relationship between fuel cell current and voltage or power density, for the vapor fed DMFC fed from the electro-osmotic pump. As shown in FIG. 9, the polarization curves show a slight decay in performance with operating time, and the current at which the peak power occurred did not vary significantly with increasing hours of operation.

In another embodiment of the method of these teachings, the durability of the direct oxidation fuel cell is increased by utilizing a flow “choke” valve in the anode feeding line. The “choke” valve has a pre-set maximum flow rate. In the embodiment in which a flow “choke” valve is utilized, fuel over-feeding can be substantially avoided.

In a further embodiment of the method of these teachings, the durability of the direct oxidation fuel cell is increased by utilizing a buffer component, for example, a chemical or physical buffer. In one instance, the chemical or physical buffer stores (in one instance, not a limitation of these teachings, absorbs) a portion of the fuel during periods of enhanced fuel supply (often referred to as “spikes”) and subsequently releases the stored portion of the fuel during periods of reduced fuel supply (often referred to as “lean periods”). In one embodiment, the buffer component includes a mesoporous or microporous silica gel that absorbs a portion of the fuel (methanol, in one instance). Altering the physical or chemical environment of the buffer component can release the absorbed portion of the fuel.

In one analogy, comparing the fuel delivery system to an electrical system, the buffer acts similar to a capacitor. In one instance, since mechanical systems can be modeled as lumped element electrical systems for design and analysis purposes, the analogous electrical model of the flow in the system including the buffer can be utilized to select the buffer component and the release process or mechanism in order to obtain desired characteristics of the reduced fluctuation in output power.

Although the teachings have been described with respect to various embodiments, it should be realized these teachings are also capable of a wide variety of further and other embodiments within the spirit and scope of the appended claims.

What is claimed is:

1. A method for increasing durability of a vapor fed direct oxidation fuel cell, the method comprising the step of:
reducing fluctuations in output power, provided by the vapor fed direct oxidation fuel cell, to a load.

2. The method of claim 1 wherein the step of reducing fluctuations in output power comprises the step of utilizing an electro-osmotic pump and a pump driver controller to supply fuel to the vapor fed direct oxidation fuel cell.

3. The method of claim 1 wherein the step of reducing fluctuations in output power comprises the step of utilizing a mass flow controller in providing fuel to the vapor fed direct oxidation fuel cell.

4. The method of claim 1 wherein the step of reducing fluctuations in output power comprises the step of reducing amplitude fluctuations in output power to less than 50%.

5. The method of claim 1 wherein the step of reducing fluctuations in output power comprises the step of reducing fluctuation frequency lower than 0.1 Hz.

6. The method of claim 1 wherein the vapor fed direct oxidation fuel cell is a vapor fed direct methanol fuel cell.

7. The method of claim 6 wherein fuel utilization is higher than 50%.

8. A method for increasing durability of a direct oxidation fuel cell, the method comprising the step of:
utilizing a flow “choke” valve in an anode feeding line of the direct oxidation fuel cell.

9. A method for increasing durability of a direct oxidation fuel cell, the method comprising the step of:
utilizing a buffer component in an anode feeding line of the direct oxidation fuel cell.

10. The method of claim 9 wherein the step of utilizing a buffer component comprises utilizing a porous silica gel as a buffer component.
